(19) United States
(12) Patent Application Publication
(10) Pub. No.: US 2023/0282927 A1
(43) Pub. Date: Sep. 7, 2023

(54) BATTERY PACK AND DEVICE INCLUDING THE SAME

(71) Applicant: LG ENERGY SOLUTION, LTD., Seoul (KR)

(72) Inventors: Juhwan SHIN, Daejeon (KR); Junyeob SEONG, Daejeon (KR); Hyoungsuk LEE, Daejeon (KR); YOUNG IL YOON, Daejeon (KR)

(73) Assignee: LG ENERGY SOLUTION, LTD., Seoul (KR)

(21) Appl. No.: 18/019,038

(22) PCT Filed: May 25, 2022
(86) PCT No.: PCT/KR2022/007401

§ 371 Date: Jan. 31, 2023

(30) Foreign Application Priority Data
Jun. 21, 2021 (KR) 10-2021-0080123

(51) Int. Cl. H01M 50/358; H01M 50/211; H01M 50/271; H01M 50/262; H01M 50/342

(52) U.S. Cl. CPC H01M 50/358; H01M 50/211; H01M 50/271; H01M 50/262; H01M 50/3425

(57) ABSTRACT

A battery pack includes a lower pack frame on which a plurality of battery cell arrays are mounted; at least one cover part located in an upper part of the plurality of battery cell arrays; and a venting part that is mounted on the cover part and extends along the longitudinal direction of the lower pack frame, wherein the cover part covers the upper part of the pair of battery cell arrays arranged so as to face each other with respect to the width direction of the lower pack frame. A first venting hole is formed on the cover part, and the venting part covers the first venting hole.

### CROSS CITATION WITH RELATED APPLICATION(S)

This application claims the benefit of Korean Patent Application No. 10-2021-0080123 filed on Jun. 21, 2021 with the Korean Intellectual Property Office, the entire contents of which are incorporated herein by reference.

### TECHNICAL FIELD

The present disclosure relates to a battery pack and a device including the same, and more particularly to a battery pack in which when gas and flame are generated in a part of battery cells, the generated gas and flame are effectively discharged to the outside of the battery pack while preventing a heat propagation phenomenon between adjacent battery cells, and a device including the same.

### BACKGROUND

Secondary batteries, which are easily applied to various product groups and has electrical characteristics such as high energy density, are universally applied not only for a portable device but also for an electric vehicle or a hybrid electric vehicle, an energy storage system or the like, which is driven by an electric driving source. Such secondary battery is attracting attention as a new environment-friendly energy source for improving energy efficiency since it gives a primary advantage of remarkably reducing the use of fossil fuels and also does not generate by-products from the use of energy at all.

Currently commercialized secondary batteries include a nickel cadmium battery, a nickel hydrogen battery, a nickel zinc battery, and a lithium secondary battery. Among them, the lithium secondary battery has come into the spotlight because they have advantages, for example, hardly exhibiting memory effects compared to nickel-based secondary batteries and thus being freely charged and discharged, and having very low self-discharge rate and high energy density.

Generally, the lithium secondary battery may be classified based on the shape of the exterior material into a cylindrical or prismatic secondary battery in which the electrode assembly is mounted in a metal can, and a pouch-type secondary battery in which the electrode assembly is mounted in a pouch made of an aluminum laminate sheet.

Recently, along with a continuous rise of the necessity for a large-capacity secondary battery structure, including the utilization of the secondary battery as an energy storage source, there is a growing demand for a battery pack of a medium- and large-sized module structure which is an assembly of battery modules in which a plurality of secondary batteries are connected in series or in parallel. In such a battery module, a plurality of battery cells are connected to each other in series or in parallel to form a battery cell stack, thereby improving capacity and output. In addition, a plurality of battery modules can be mounted together with various control and protection systems such as a BMS (battery management system) and a cooling system to form a battery pack.

In particular, the battery pack is composed of a structure made by combining a plurality of battery modules, and when a part of battery modules become an overvoltage, overcurrent or overheat state, the safety and operating efficiency of the battery pack may be problematic. In particular, in order to improve the mileage, the battery pack capacity tends to gradually increase.

As the energy inside the pack increases accordingly, it is necessary to design a structure that meets the strengthened safety standards and ensures the safety of vehicles and drivers. For this purpose, particularly, in order to prevent a thermal runaway within the battery pack and a heat propagation phenomenon between battery cells in advance, there is a growing need for a structure capable of effectively discharging gases and flames generated in a part of battery cells and minimizing the damage.

### DETAILED DESCRIPTION OF THE INVENTION

### Technical Problem

It is an object of the present disclosure to provide a battery pack in which when gas and flame are generated in a part of battery cells, the generated gas and flame are effectively discharged to the outside of the battery pack while preventing a heat propagation phenomenon between adjacent battery cells, and a device including the same.

The objects of the present disclosure are not limited to the above-mentioned objects, and other objects which are not described herein should be clearly understood by those skilled in the art from the following detailed description and the accompanying drawings.

### Technical Solution

According to an embodiment of the present disclosure, there is provided a battery pack comprising: a lower pack frame on which a plurality of battery cell arrays are mounted; at least one cover part located in an upper part of the plurality of battery cell arrays; and a venting part that is mounted on the cover part and extends along the longitudinal direction of the lower pack frame, wherein the cover part covers the upper part of the pair of battery cell arrays arranged so as to face each other with respect to the width direction of the lower pack frame, and wherein a first venting hole is formed on the cover part, and the venting part covers the first venting hole.

The cover part may include a first plate, a second plate located in a lower part of the first plate, and a side surface part that connects an edge of the first plate and an edge of the second plate.

The first venting hole may be formed in a central part of the first plate.

A lower surface of the second plate may make contact with an upper part of the battery cell array.

At least one second venting hole may be formed in the second plate, with the second venting hole being formed at a position adjacent to the front and rear surfaces of the battery cell array.

The venting part may include a first venting part extending along the length direction of the cover part and a second venting part extending in a direction perpendicular to the first venting part.

The second venting part may extend up to the bottom surface of the cover part through the center of the first venting hole.

The lower pack frame may include a bottom part in contact with the lower surface of the battery cell array, and a frame part in contact with at least one side surface of the battery cell array.

The frame part may be made of a heat insulating member.

The frame part may include a side surface frame extending from the edge of the bottom part toward the upper part, and an inner frame located inside the side surface frame, and the plurality of battery cell arrays may be divided each other by the side surface frame and the inner frame.

The battery pack may further include a first fastening member that fixes a part of an edge of the cover part to an upper part of the inner frame, and further include a second fastening member that fixes a part of an edge of the venting part to an upper surface of the cover part.

At least one rupture part is formed on the outer surface of the side surface frame, and the rupture part may be located adjacent to one end of the venting part.

At least one through part is formed on the inner surface of the side surface frame, and the through part may communicate with one end of the venting part.

According to another embodiment of the present disclosure, there is provided a device comprising the above-mentioned battery pack.

### Advantageous Effects

According to the embodiments, the present disclosure relates to a battery pack that includes a cover part and a venting part for guiding a discharge direction of gas and flame, and a device comprising the same. When gas and flame are generated in some battery cells, the gas and flame can be guided and discharged in a certain direction, whereby the generated gas and flame can be effectively discharged to the outside of the battery pack while preventing a heat propagation phenomenon between adjacent battery cells.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view of a battery pack according to an embodiment of the present disclosure;

FIG. 2 is an exploded perspective view of a cover part and a venting part in the battery pack of FIG. 1;

FIG. 3 is a perspective view which shows the remaining components excluding a cover part and a venting part in the battery pack of FIG. 1;

FIG. 4 is an exploded perspective view of a lower pack frame in the battery pack of FIG. 1;

FIG. 5 is a cross-sectional view of the cover part of FIG. 2 taken along the cutting line C-C′;

FIG. 6 is an enlarged view of a region a of FIG. 1;

FIG. 7 is a diagram which shows a part of a cross section taken along the cutting line A-A′ of FIG. 1;

FIG. 8 is a diagram which enlarges and shows a part of FIG. 7; and

FIG. 9 is a diagram which shows a part of a cross section taken along the cutting line B-B′ of FIG. 1.

### DETAILED DESCRIPTION OF THE EMBODIMENTS

Hereinafter, various embodiments of the present disclosure will be described in detail with reference to the accompanying drawings so that those skilled in the art can easily carry out them. The present disclosure can be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity.

In the drawings, for convenience of description, the thicknesses of some layers and regions are exaggerated.

Further, throughout the description, when a portion is referred to as “including” or “comprising” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

Now, the battery pack according to an embodiment of the present disclosure will be described.

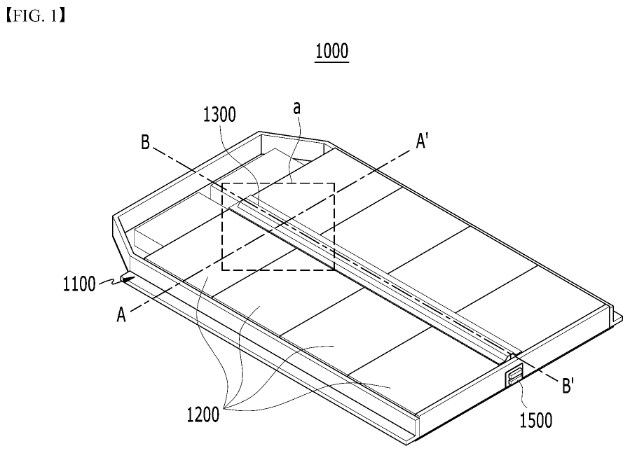

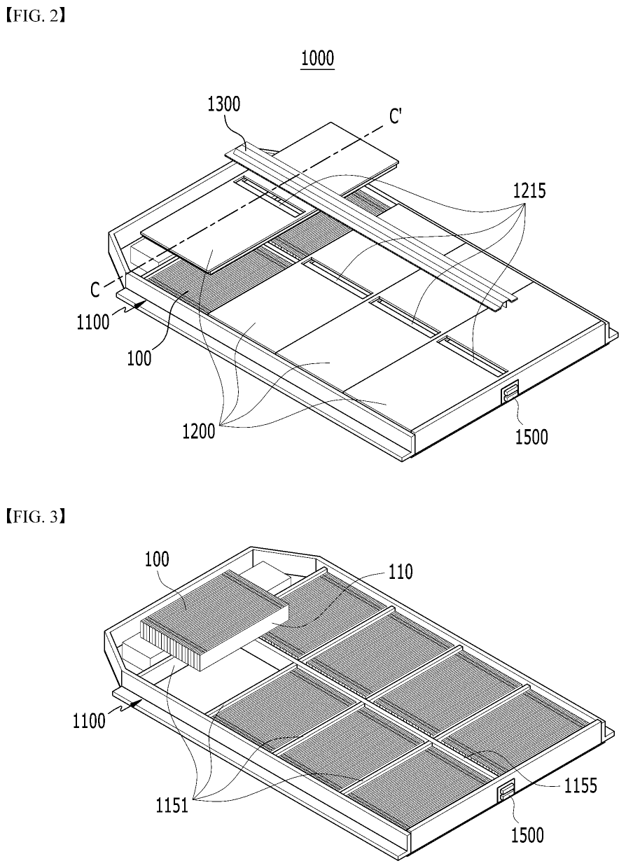

FIG. 1 is a perspective view of a battery pack according to an embodiment of the present disclosure. FIG. 2 is an exploded perspective view of a cover part and a venting part in the battery pack of FIG. 1.

Referring to FIGS. 1 and 2, a battery pack 1000 according to an embodiment of the present disclosure includes a lower pack frame 1100 on which a plurality of battery cell arrays 100 are mounted; at least one cover part 1200 located in an upper part of the plurality of battery cell arrays 100; and a venting part 1300 that is mounted on the cover part 1200 and extends along the longitudinal direction of the lower pack frame 1100.

More specifically, the cover part 1200 may extend along the width direction of the lower pack frame 1100. Here, the width direction of the lower pack frame 1100 may be the same as the length direction of the pair of battery cell arrays 100 arranged so as to face each other.

Also, the cover part 1200 may cover the upper part of the pair of battery cell arrays 100 arranged so as to face each other with respect to the width direction of the lower pack frame 1100. More specifically, the cover parts 1200 may be respectively located above the pair of battery cell arrays 100 mounted on the lower pack frame 1100.

Here, the cover part 1200 may include a plurality of cover units 1200 divided for each pair of battery cell arrays 100 as shown in FIGS. 1 and 2. Further, unlike FIGS. 1 and 2, the cover part 1200 may be configured such that a plurality of cover parts 1200 are integrated with each other.

Also, a first venting hole 1215 may be formed on the cover part 1200. More specifically, the first venting hole 1215 may be formed in the upper part of the cover part 1200, and also may be formed in the upper center of the cover part 1200. Further, the venting part 1300 may cover the first venting hole 1215 formed on the cover part 1200. In other words, the first venting hole 1215 may be formed at a position facing the venting part 1300.

Here, the first venting hole 1215 may extend along the width direction of the cover part 1200. In other words, the first venting hole 1215 may extend along the longitudinal direction of the venting part 1300.

Thereby, in the battery pack 1000 according to an embodiment of the present disclosure, when an ignition phenomenon occurs in a part of the battery cell arrays 100, a high-temperature gas and a flame may be discharged through the first venting hole 1215 of the cover part 1200 that are located in the upper part of the battery cell arrays 100. In addition, the gas and flame discharged through the first venting hole 1215 can be flowed into the venting part 1300 to guide venting in the longitudinal direction of the venting part 1300, thereby preventing a heat propagation between adjacent battery cell arrays 100.

FIG. 3 is a perspective view which shows the remaining components excluding a cover part and a venting part in the battery pack of FIG. 1.

Referring to FIGS. 1 and 3, the battery pack 1000 according to an embodiment of the present disclosure may be configured that a plurality of battery cell arrays 100 are mounted on a lower pack frame 1100.

Wherein, the battery cell 110 is preferably a pouch-type battery cell. As an example, the battery cell 110 can be manufactured by housing the electrode assembly in a pouch case of a laminated sheet containing a resin layer and a metal layer, and then heat-sealing a sealing portion of the pouch case. Such a battery cell 110 may be formed in a rectangular sheet-like structure. Such a battery cell 110 may be configured by a plurality of number, and the plurality of battery cells 110 can be stacked so as to be electrically connected to each other, thereby forming a battery cell array 100.

Further, the battery cell array 100 may have a structure in which a plurality of battery cells 110 are stacked, but at least a part of the components in the battery module unit are omitted. In other words, the battery cell array 100 may have a structure in which the components in a battery module unit are minimized. As an example, the battery cell array 100 may have a structure in which busbar frames are located on the front surface and the rear surface of the battery cell stack, but the module frame in the battery module unit is omitted. That is, the battery pack 1000 according to the present embodiment has a CTP (Cell To Pack) structure in which the battery cell array 100 in which at least a part of the battery module units are omitted is mounted directly on the lower pack frame 1100.

Thereby, in the battery pack 1000 according to the present embodiment, at least a part of the battery module units are omitted, so that the weight of the battery pack 1000 can be reduced and the battery capacity can also be improved. In addition, in the present embodiment, the cover part 1200 is mounted on the upper part of the battery cell array 100, and the battery cell array 100 is not exposed to the outside, so that that safety can be improved and the structural stiffness inside the battery pack 1000 can also be sufficiently secured.

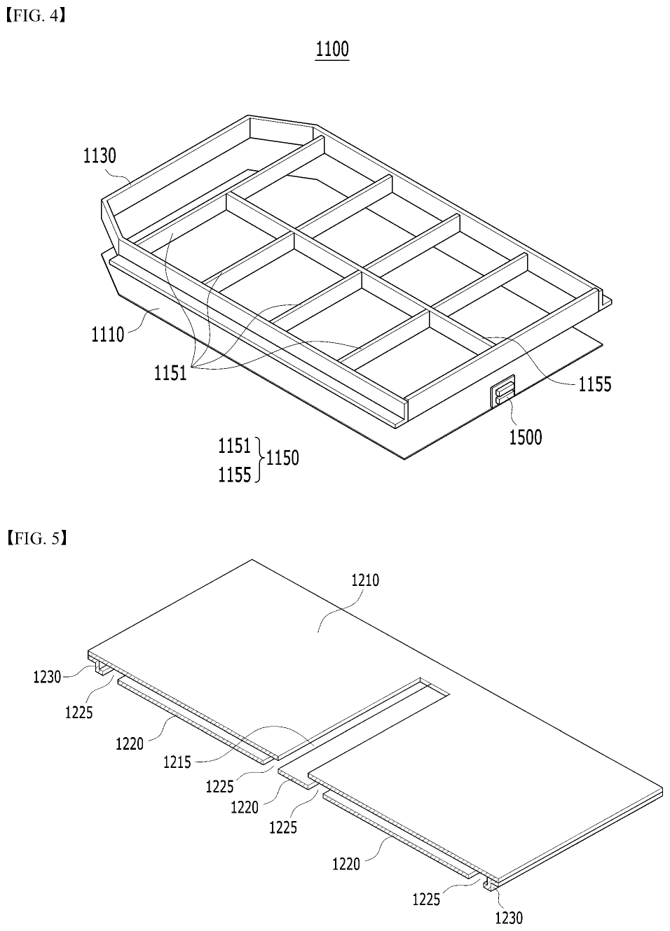

FIG. 4 is an exploded perspective view of a lower pack frame in the battery pack of FIG. 1. Referring to FIGS. 1, 3 and 4, in the battery pack 1000 according to an embodiment of the present disclosure, the lower pack frame 1100 may include a bottom part 1110 in contact with the lower surface of the battery cell array 100, and frame parts 1130 and 1150 in contact with at least one side of the battery cell array 100. Here, the bottom part 1110 and the frame parts 1130 and 1150 may be integrated with each other, or may be fixed to each other by a separate fastening method such as welding or bonding.

Here, the frame parts 1130 and 1150 can be formed of a heat insulating member. As an example, the frame parts 1130 and 1150 may be constituted of an aluminum extrusion structure.

As another example, the frame parts 1130 and 1150 are made of a dissimilar metal bonding material such as clad metal, or may be a structure containing an insulating material such as aerogel or EPP (Expanded Polypropylenes) foam. However, the present disclosure is not limited thereto, and the frame parts 1130 and 1150 can be used without limitation as long as they are made of a heat insulating material having a predetermined stiffness.

Further, the frame parts 1130 and 1150 may include a side surface frame 1130 extending from the edge of the bottom 1110 toward the upper part, and an inner frame 1150 located inside the side surface frame 1130. Here, the plurality of battery cell arrays 100 may be divided each other by a side surface frame 1130 and an inner frame 1150.

More specifically, the inner frame 1150 may include a first inner frame 1151 extending along the width direction of the lower pack frame 1100 and a second inner frame 1155 extending along the longitudinal direction of the lower pack frame 1100. The pair of first inner frames 1151 may cover both side surfaces of the battery cell array 100. Further, as shown in FIG. 3, the second inner frame 1155 and the side surface frame 1130 may cover the front and rear surfaces of the battery cell array 100.

Thereby, the frame parts 1130 and 1150 may cover both side surfaces and the front and rear surfaces of the battery cell array 100, so that the battery cell array 100 can be protected from external impact and also the structural stiffness of the pack frame 1100 can also be secured. Further, the heat propagation between adjacent battery cell arrays 100 can be prevented, thus, preventing a short circuit between the battery cells 110.

Further, referring to FIGS. 1, 3 and 4, at least one rupture part 1500 may be formed on the outer surface of the side surface frame 1130. Here, the rupture part 1500 may be located adjacent to one end of the venting part 1300. In other words, the rupture part 1500 is located on the outer surface of the side surface frame 1130 in contact with the end of the second inner frame 1155, but may be located adjacent to one end of the venting part 1300.

Further, the rupture part 1500 may be connected to the venting part 1300, like a rupture disc, and may include a rupture surface (not shown) configured to rupture when the pressure of the inflowing gas is a certain pressure or higher. However, the structure of the rupture part 1500 is not limited thereto, and it can be included in the present embodiment as long as it is a configuration that communicates with the passage of the venting part 1300 to enable discharge to the outside.

According to the above configuration, the venting part 1300 and the rupture part 1500 may be in communication with each other, whereby when an ignition phenomenon occurs in a part of battery cell arrays 100, the heat and flame are guided to the outside and the influence between adjacent battery cell arrays 100 can be minimized.

FIG. 5 is a cross-sectional view of the cover part of FIG. 2 taken along the cutting line C-C′. Referring to FIGS. 2 and 5, the cover part 1200 may include a first plate 1210, a second plate 1220 located under the first plate 1210, and a side surface part 1230 for connecting the edge of the first plate 1210 and the edge of the second plate 1220. Here, the first plate 1210, the second plate 1220, and the side surface part 1230 may be integrated with each other, or may be fixed to each other by a separate fastening method such as welding or bonding.

Further, a first venting hole 1215 may be formed in the central part of the first plate 1210. Here, the first venting hole 1215 may mean a portion that is opened in the first place 1210 by removing a part of the first plate 1210 as shown in FIG. 5.

Further, at least one second venting hole 1225 may be formed in the second plate 1220. Here, the second venting hole 1225 may be formed in a position adjacent to the front and rear surfaces of the battery cell array 100. More specifically, the cover part 1200 may be located in the upper part of the pair of battery cell arrays 100, and the second venting holes 1225 may be respectively formed at positions adjacent to the front and rear surfaces of the pair of battery cell arrays 100. As an example, as shown in FIG. 5, the four second venting holes 1225 may be respectively formed at positions adjacent to the front and rear surfaces of the pair of battery cell arrays 100. Here, the second venting hole 1225 may mean a portion that is opened in the second plate 1220 by removing a part of the second plate 1220, similarly to the first venting hole 1215.

Thereby, in the battery pack 1000 according to the present embodiment, when an ignition phenomenon occurs in a part of battery cell arrays 100, the gas and flame flow into the cover part 1200 through the second venting holes 1225 located adjacent to the front and rear surfaces of the battery cell array 100, and the gas and flame that have flowed into the second venting hole 1225 can be discharged toward the venting part 1300 through the first venting hole 1215.

Further, a lower surface of the second plate 1220 may make contact with an upper part of the battery cell array 100. More specifically, in the present embodiment, the cover part 1200 makes contact with the upper part of the battery cell array 100, and can be fastened by pressing the upper part of the battery cell array 100.

Thereby, the cover part 1200 acts as a support frame that stably supports the battery cell array 100 during normal times, other than when an ignition phenomenon occurs, thereby improving the stability while securing structural stiffness of the battery pack 1000.

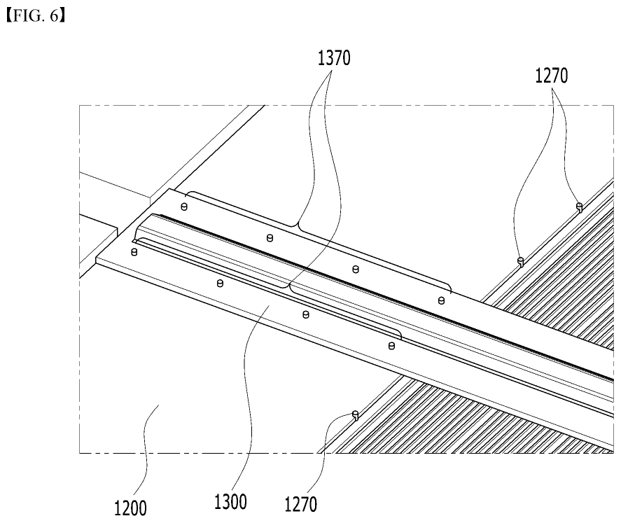

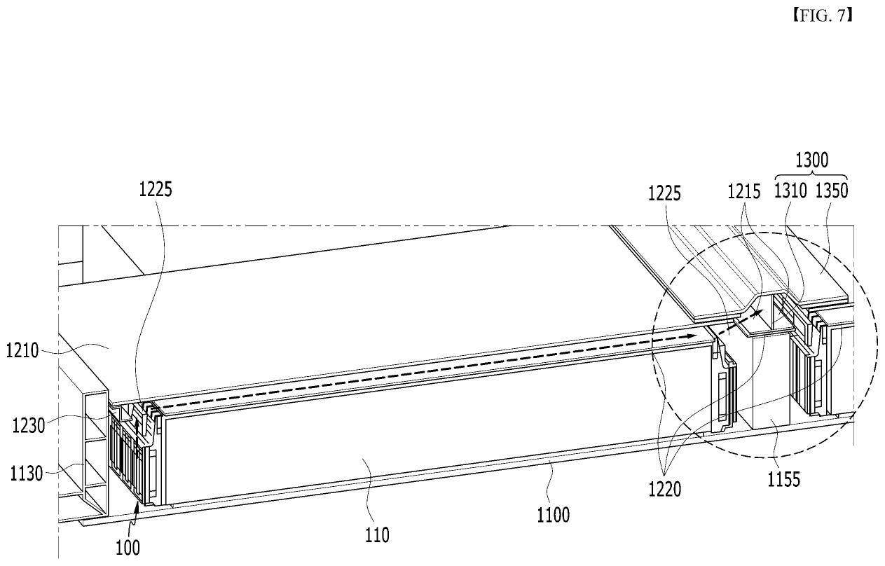

FIG. 6 is an enlarged view of a region a of FIG. 1.

Referring to FIGS. 1, 3 and 6 , in the battery pack 1000 according to the present embodiment, the cover part 1200 and the venting part 1300 may be fixed to the lower pack frame 1100 by the first fastening member 1270 and the second fastening member 1370.

More specifically, the first fastening member 1270 can fix a part of the edge of the cover part 1200 to the upper part of the inner frame 1150. Further, the second fastening member 1370 can fix a part of the edge of the venting part 1300 to the upper surface of the cover part 1200.

As an example, the first fastening member 1270 and the second fastening member 1370 may be composed of a sealing weld bolt. As another example, the first fastening member 1270 and the second fastening member 1370 are respectively formed by at least one of a metal joining by spot welding, a rivet joining, and a structural sealant joining. However, the first fastening member 1270 and the second fastening member 1370 are not limited thereto, and can be included in the present embodiment as long as it is a configuration or method capable of stably fixing the cover part 1200 and the venting part 1300 to the lower pack frame 1100.

Thereby, in the battery pack 1000 according to the present embodiment, the cover part 1200 and the venting part 1300 can be stably fixed to the lower pack frame 1100 by the first fastening member 1270 and the second fastening member 1370, thereby improving the structural stability of the battery pack 1000. Further, the space between the cover part 1200 and the venting part 1300 can be sealed, so that when an ignition phenomenon occurs in a part of battery cell arrays 100, the generated flames and gases may not leak between the cover part 1200 and the venting part 1300.

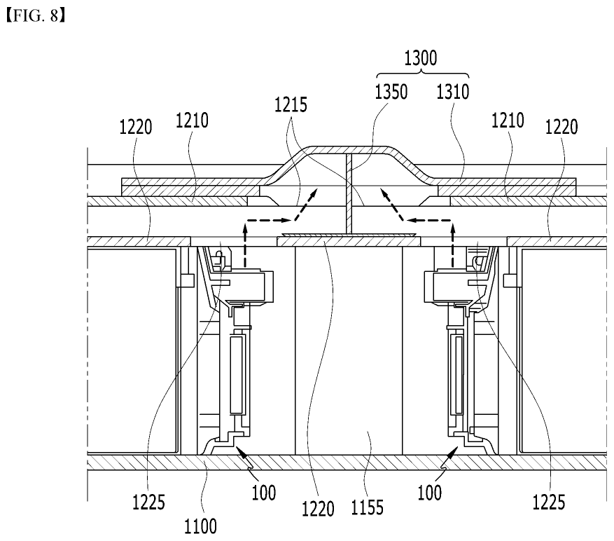

FIG. 7 is a diagram which shows a part of a cross section taken along the cutting line A-A′ of FIG. 1. FIG. 8 is a diagram which enlarges and shows a part of FIG. 7.

Referring to FIGS. 1, 7 and 8, when an ignition phenomenon occurs in the battery cell array 100, the gas and flame generated in the battery cell array 100 can flow into the second venting hole 1225 adjacent to the front and rear surfaces of the battery cell array 100. Further, the gas that has flowed into the second venting hole 1225 may move through the inside of the cover part 1200, and the moved gas and flame may flow into the venting part 1300 through the first venting hole 1215.

Thereby, in the battery pack 1000 according to the present embodiment, the gas and flame generated in a part of the battery cell arrays 100 can guide venting along the width direction of the battery pack 1000 through the cover part 1200 and the venting part 1300, thereby preventing the heat propagation between adjacent battery cell arrays 100.

Further, referring to FIGS. 7 and 8, in the battery pack 1000 according to the present embodiment, the venting part 1300 may include a first venting part 1350 extending along the longitudinal direction of the cover part 1200 and a second venting part 1310 extending in a direction perpendicular to the first venting part 1350. More specifically, the second venting part 1310 may extend up to the bottom surface of the cover part 1200 through the center of the first venting hole 1215.

Thereby, in the battery pack 1000 according to the present embodiment, the venting part 1300 may be divided by the second venting part 1310, so that the gas and the flame flowing into the venting part 1300 can be prevented from being transmitted to each other between the pair of battery cell arrays 100 and causing heat propagation.

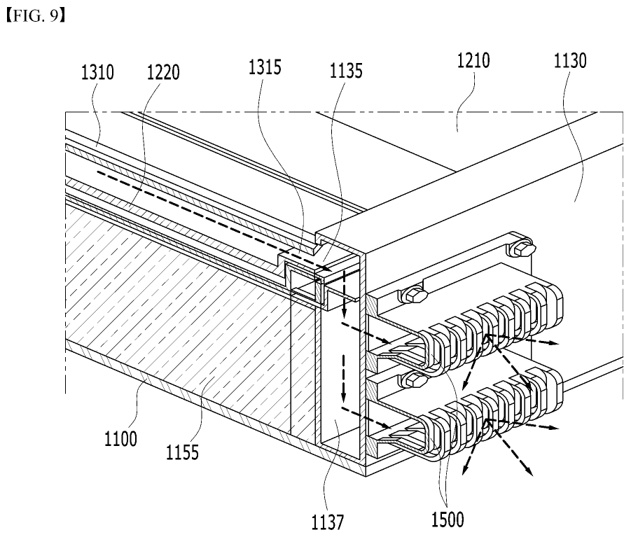

FIG. 9 is a diagram which shows a part of a cross section taken along the cutting line B-B′ of FIG. 1.

Referring to FIGS. 1 and 9, the gas and flame flowing through the venting part 1300 may move toward the rupture part 1500 formed in the side surface frame 1130, and the rupture part 1500 may be ruptured when the pressure is not less than the predetermined value, so that high-temperature gas and flame may be discharged to the outside.

Here, at least one through part 1135 may be formed on the inner surface of the side surface frame 1130. Here, the through part 1135 can communicate with one end 1315 of the venting part 1300 as shown in FIG. 9. Further, a gas collection part 1137 capable of collecting gas and flame may be formed inside the side surface frame 1130. As an example, the gas collection part 1137 may have a size corresponding to the size of the rupture part 1500.

More specifically, the gas and flame flowing in through the venting part 1300 may move to the gas collection part 1137 through the through part 1135 communicating with one end 1315 of the venting part 1300. Additionally, when the pressure of the gas and the flame collected in the gas collection part 1137 is equal to or greater than a predetermined pressure, the rupture part 1500 may rupture and the gas and the flame can be discharged to the outside of the side surface frame 1130.

Thereby, in the battery pack 1000 according to the present embodiment, the gas and flame flowing into the venting part 1300 through the venting part 1300 and the rupture part 1500 can guide venting along the longitudinal direction of the battery pack 1000, so that gases and flames can be effectively discharged to the outside while preventing heat propagation between adjacent battery cell arrays 100.

The device according to another embodiment of the present disclosure include the above-mentioned battery pack. Such a device can be applied to a vehicle means such as an electric bicycle, an electric vehicle, or a hybrid vehicle, but the present disclosure is not limited thereto, and is applicable to various devices that can use a battery module and a battery pack including the same, which is also falls within the scope of the present disclosure.

Although preferred embodiments of the present disclosure have been described in detail above, the scope of the present disclosure is not limited thereto, and numerous other modifications and embodiments can be devised by those skilled in the art, without departing from the spirit and scope of the principles of the invention described in the appended claims

### DESCRIPTION OF REFERENCE NUMERALS

100: battery cell array
1000: battery pack
1100: lower pack frame
1200: cover part
1300: venting part
1500: rupture part

1. A battery pack comprising:
a lower pack frame on which a plurality of battery cell arrays are mounted;
at least one cover located on an upper part of the plurality of battery cell arrays; and
a vent that is mounted on the cover and extends along a longitudinal direction of the lower pack frame,
wherein the cover covers the upper part of a pair of battery cell arrays of the plurality of battery cell arrays arranged so as to face each other with respect to a width direction of the lower pack frame, and
wherein a first venting hole is formed in the cover, and the vent covers the first venting hole.

2. The battery pack according to claim 1, wherein:
the cover comprises a first plate, a second plate located below the first plate, and a side surface that connects an edge of the first plate and an edge of the second plate.

3. The battery pack according to claim 2, wherein:
the first venting hole is formed in a central part of the first plate.

4. The battery pack according to claim 3, wherein:
a lower surface of the second plate makes contact with the upper part of a first battery cell array of the plurality of battery cell arrays.

5. The battery pack according to claim 4, wherein:
at least one second venting hole is formed in the second plate, with the second venting hole being formed at a position adjacent to a front surface or a rear surface of the first battery cell array.

6. The battery pack according to claim 1, wherein:
the vent comprises a first venting part extending along the longitudinal direction of the lower pack frame and a second venting part extending in the width direction of the lower pack frame.

7. The battery pack according to claim 6, wherein:
the second venting part extends up to a bottom surface of the cover through a center of the first venting hole.

8. The battery pack according to claim 1, wherein:
the lower pack frame comprises a bottom part in contact with a lower surface of the plurality of battery cell arrays, and a frame part in contact with at least one side surface of the plurality of battery cell arrays.

9. The battery pack according to claim 8, wherein:
the frame part is made of a heat insulating member.

10. The battery pack according to claim 8, wherein:
the frame part comprises a side surface frame extending from an edge of the bottom part of the lower pack frame toward the upper part of the plurality of battery cell arrays, and an inner frame located inside the side surface frame, and
the plurality of battery cell arrays are divided from each other by the side surface frame and the inner frame.

11. The battery pack according to claim 10, further comprising:
a first fastening member that fixes a part of an edge of the cover to an upper part of the inner frame, and
a second fastening member that fixes a part of an edge of the vent to an upper surface of the cover.

12. The battery pack according to claim 10, wherein:
at least one rupture part is formed on an outer surface of the side surface frame, and the rupture part is located adjacent to a first end of the vent.

13. The battery pack according to claim 12, wherein:
at least one through part is formed on an inner surface of the side surface frame, and the through part communicates with the first end of the vent.

14. A device comprising the battery pack of claim 1.
